(19) United States
(12) Patent Application Publication
(10) Pub. No.: US 2006/0186574 A1
(43) Pub. Date: Aug. 24, 2006

(54) Web-shaped structure formed by plastic material and the method for making the same

(76) Inventor: Yang Teng Jen, Wufong Township (TW)

Correspondence Address: CHARLES E. BAXLEY, ESQ., 90 JOHN STREET, THIRD FLOOR, NEW YORK, NY, 10038, US

(21) Appl. No.: 11/063,397

(22) Filed: Feb. 22, 2005

(51) Int. Cl. B29C 45/16

(52) U.S. Cl. 264/250; 264/255

(57) ABSTRACT

A method for making a web-shaped structure formed by plastic material, comprising: forming a first plastic member in a mold by a first ejection molding process, the first plastic member being provided with a plurality of combination strips, and then forming a second plastic member integrally combined with the first plastic member by a second ejection molding process, wherein the second plastic member is provided with a plurality of combination strips which are interwoven with the combination strips of the first plastic member, thus forming a web-shaped structure.

This application is a Continuation-in-Part of U.S. patent application Ser. No. 2004/0145171, to which application priority is claimed.

### BACKGROUND OF THE INVENTION

1. Field of the Invention

The present invention relates to a web-shaped structure formed by plastic material, and more particularly to a web-shaped structure formed by plastic material and the method for making the same, wherein the web-shaped structure may be made through two steps of ejection molding process.

2. Description of the Related Art

U.S. Pat. No. 5,128,195 discloses a woven structure which is woven by a first and a second combination stripes, since the first and the second combination stripes are made of paper, the web-shaped structure only can be weaving by manual, thus increasing the fabrication cost while reducing the capability of mass production.

Furthermore, U.S. Pat. No. 3,574,103 discloses another woven structure comprising a first laminar sheet and a second laminar sheet, so it is feasible for mass production. However, the second laminar sheet is disposed in stacked relation to the first laminar sheet, they are simply overlapped but not interwoven together, and the connection between the first laminar sheet and the second laminar sheet is achieved by means of gluing. Thereby, connection between the first laminar sheet and the second laminar sheet is not strong and it is likely to be broken when subjected to an external force.

### SUMMARY OF THE INVENTION

The present invention has arisen to mitigate and/or obviate the disadvantage of the conventional web-shaped product.

The primary objective of the present invention is to provide a web-shaped structure formed by plastic material, wherein the web-shaped structure may be used to make a product, such as the cellular phone bag, the hand bag, the basket or the like, so that the product has a corrugated and web-shaped spatial effect, thereby enhancing the aesthetic quality of the product.

Another objective of the present invention is to provide a web-shaped structure formed by plastic material, wherein the web-shaped structure is integrally manufactured by a plastic injection molding process, thereby saving the cost of fabrication.

A further objective of the present invention is to provide a web-shaped structure formed by plastic material, wherein the web-shaped structure has an integrally formed figure with variation of the pattern, thereby enhancing the aesthetic quality of the product.

A further objective of the present invention is to provide a web-shaped structure formed by plastic material, wherein the figure of the web-shaped structure will not become vague, fade or vanish due to frequent contact with water during a long-term utilization, thereby enhancing the durability of the product.

A further objective of the present invention is to provide a web-shaped structure formed by plastic material, wherein the elongated rails of the first plastic member and the elongated rails of the second plastic member co-operate to prevent separation of first plastic member from the second plastic member.

A further objective of the present invention is to provide a web-shaped structure formed by plastic material, wherein be design of the elongated rails of the first plastic member and the second plastic member, the product may be sewn or bonded on the shoe vamp or a predetermined position.

A further objective of the present invention is to provide a web-shaped structure formed by plastic material, wherein each of the combination strips of the first plastic member is arranged in an arc-shaped and corrugated manner, and each of the combination strips of the second plastic member is arranged in an arc-shaped and corrugated manner, thereby enhancing the aesthetic quality of the product.

In accordance with the present invention, there is provided a web-shaped structure formed by plastic material, comprising a first plastic member, and a second plastic member combined with the first plastic member integrally, wherein:

the first plastic member is provided with a plurality of combination strips; and

the second plastic member is provided with a plurality of combination strips, each of the combination strips of the second plastic member is mounted on the top end face of one of the combination strips of the first plastic member and is mounted on the bottom end face of the adjacent combination strip of the first plastic member, so that each of the combination

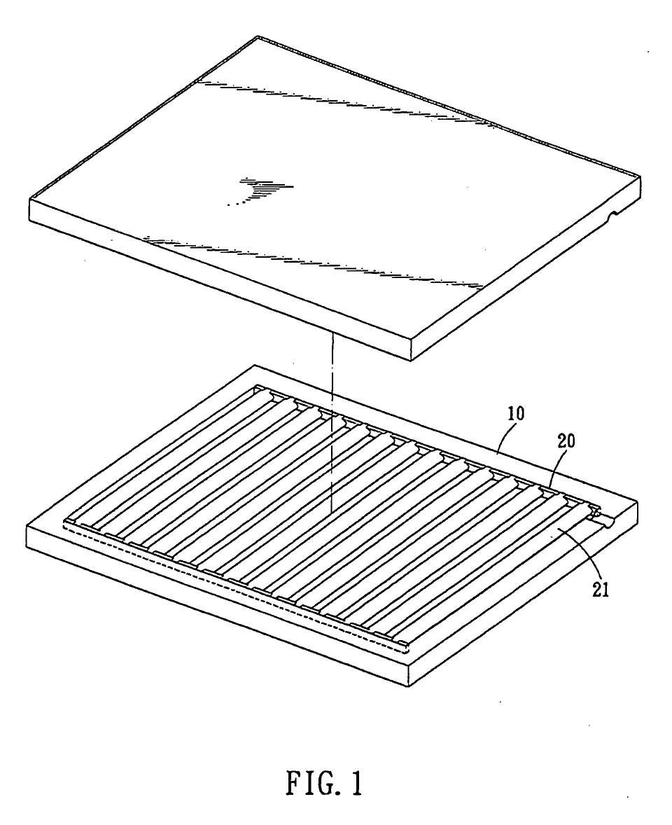

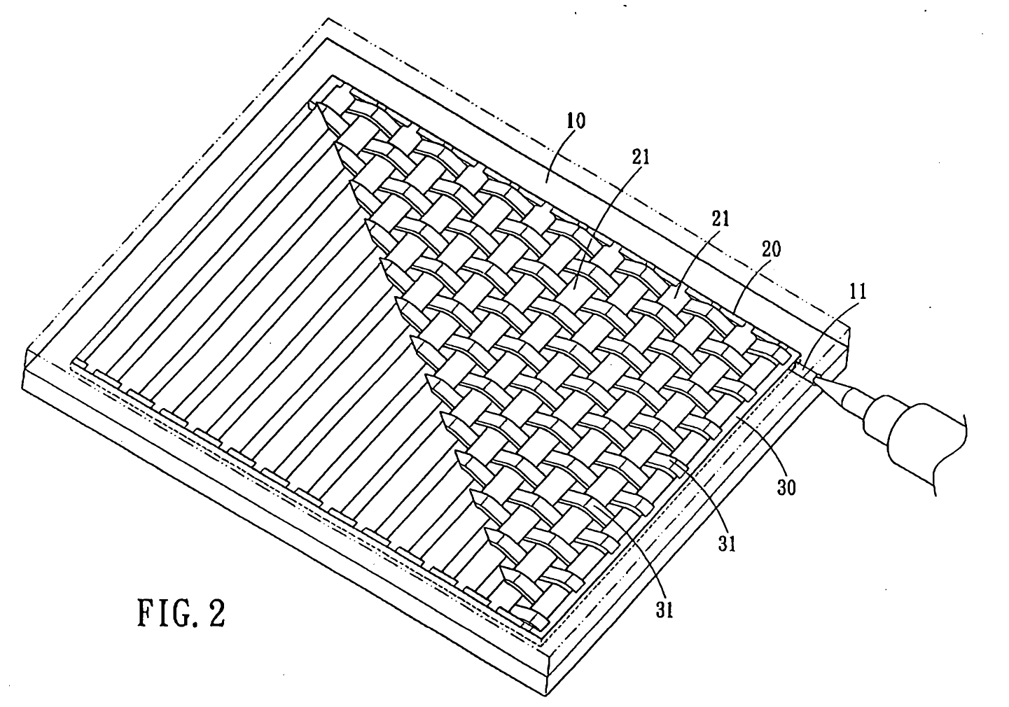

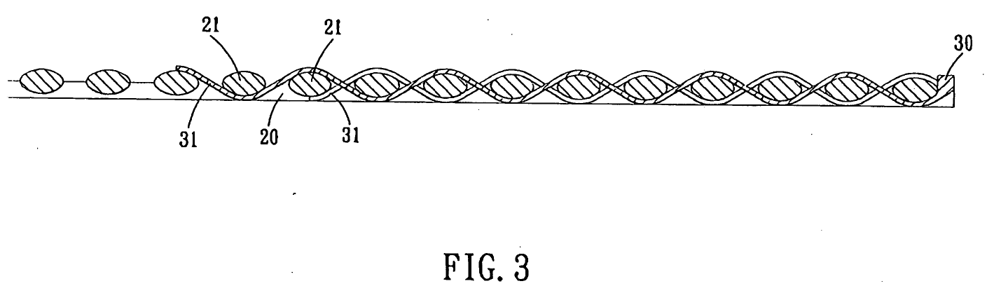

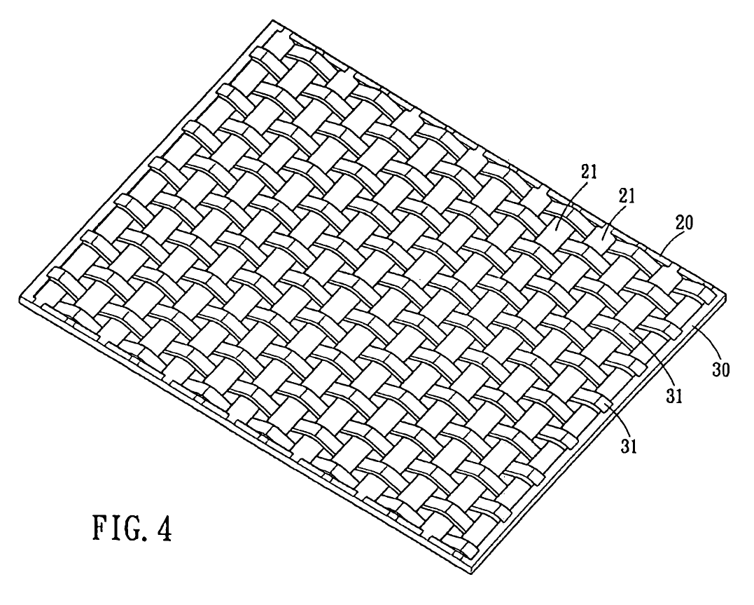

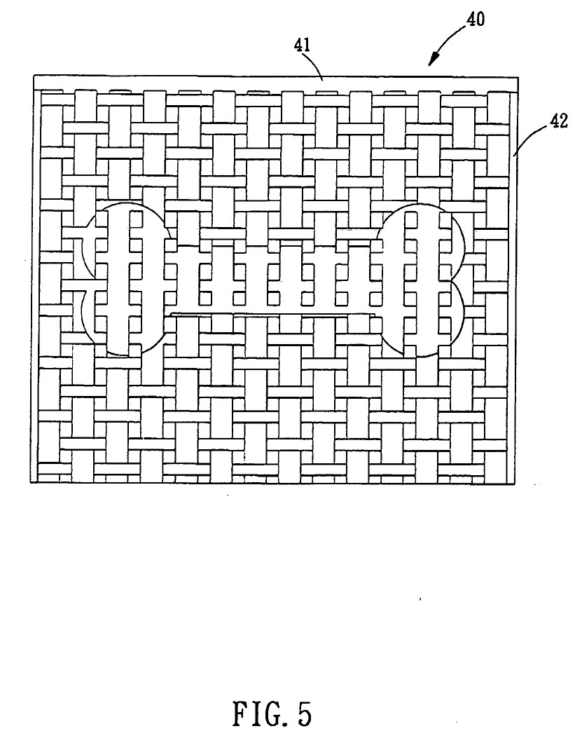

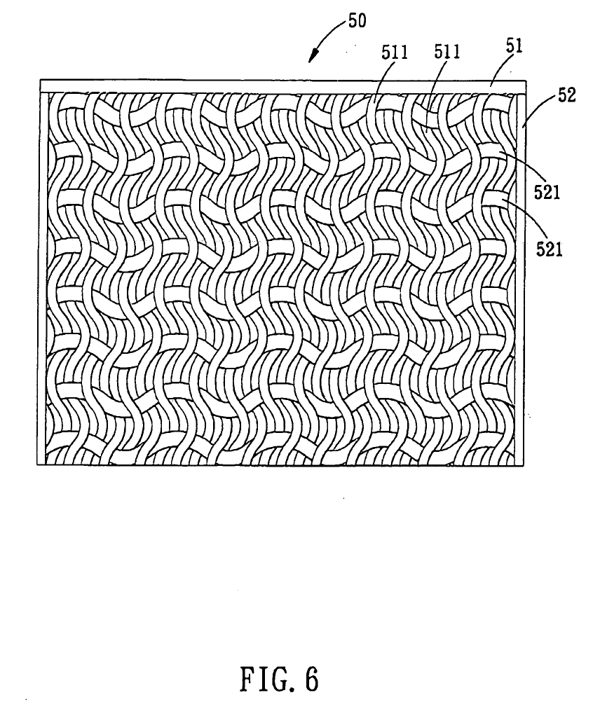

Referring to the drawings and initially to FIGS. 1-4, which shows a plastic web-shaped structure formed by a method in accordance with a first embodiment of the present invention comprises a first plastic member 20, and a second plastic member 30 interwoven with the first plastic member 20 integrally. And the method for making the web-shaped structure comprises the following steps: First, forming the first plastic member 20 in a mold 10 by a first ejection molding process, as shown in FIG. 1. The first plastic member 20 is provided with a plurality of combination strips 21 which are arranged in a parallel manner and are spaced apart from each other. Second, forming the second plastic member 30 combined with the first plastic member 20 integrally by a second ejection molding process, as shown in FIG. 2 and 3, the second plastic member 30 is provided with a plurality of combination strips 31 which are interwoven with the combination strips 21 of the first plastic member 20, thus forming a web-shaped structure, as shown in FIG. 4. It is to be noted that, during the second ejection molding process, the combination stripes 31 of the second plastic member 30 interwoven with the combination strips 21 of the first plastic member 20 are formed gradually inward from the filling opening 11 of the mold 10. In other words, the closer to the filling opening 11 of the mold 10, the earlier the combination stripes 31 of the second plastic member 30 will be formed.

As mentioned above, a plastic web-shaped structure comprising a first plastic member interwoven with a second plastic can be fabricated through the first and the second plastic ejection molding process, thereby saving the cost of fabrication while increasing the manufacturing capacity.

What is claimed is:

1. A method for making a web-shaped structure formed by plastic material, comprising: forming a first plastic member in a mold by a first ejection molding process, the first plastic member being provided with a plurality of combination strips, and then forming a second plastic member integrally combined with the first plastic member by a second ejection molding process, wherein the second plastic member is provided with a plurality of combination strips which are interwoven with the combination strips of the first plastic member, thus forming a web-shaped structure.

2. The method for making a web-shaped structure formed by plastic material in accordance with claim 1, wherein the first ejection molding process and the second ejection molding process are carried out in the same mold.

3. The method for making a web-shaped structure formed by plastic material in accordance with claim 1, wherein the first ejection molding process and the second ejection molding process are carried out in two different molds.
